(19) United States
(12) Patent Application Publication
(10) Pub. No.: US 2026/0233693 A1
(43) Pub. Date: Aug. 13, 2026

(54) METHOD AND SYSTEM FOR CONTROLLING VEHICLE BASED ON REAL-TIME INFORMATION

(71) Applicant: HL Klemove Corp., Incheon (KR)

(72) Inventor: Jonghyun CHA, Incheon (KR)

(73) Assignee: HL Klemove Corp., Incheon (KR)

(21) Appl. No.: 19/288,003

(22) Filed: Aug. 1, 2025

(30) Foreign Application Priority Data
Feb. 13, 2025 (KR) 10-2025-0018591

(51) Int. Cl. B60R 21/0134; B60R 21/013; B60T 7/22

(52) U.S. Cl. CPC B60R 21/0134; B60T 7/22; B60R 2021/01311; B60T 2210/10; B60T 2210/32; B60T 2210/36; B60T 2260/09

(57) ABSTRACT

A method and a system for controlling a vehicle based on real-time information are provided, and the method for controlling a vehicle based on real-time information according to an embodiment of the present disclosure comprises: recognizing a front vehicle of an ego vehicle; collecting real-time information of a driving road of the ego vehicle from a cloud server; determining a danger level based on the real-time information from the cloud server; controlling an Autonomous Emergency Braking (AEB) function of the ego vehicle based on the danger level; and controlling the ego vehicle according to the controlled AEB function.

### CROSS-REFERENCE TO RELATED APPLICATION

This application claims the benefit of and priority to Korean Patent Application No. 10-2025-0018591 filed on Feb. 13, 2025, the entire disclosures of which are incorporated herein by reference.

### TECHNICAL FIELD

The present disclosure relates to a method and system for controlling a vehicle based on real-time information. More specifically, the present disclosure relates to a method and system for controlling a vehicle based on real-time information, configured to calculate a danger score based on real-time information provided from a cloud server, and control an Autonomous Emergency Braking function of the vehicle according to a danger level based on the calculated danger score.

### BACKGROUND

In a vehicle, a Driver Assistance System provides support to the driver while driving for the driver's convenience.

For example, Autonomous Emergency Braking (AEB) systems, which automatically execute braking when a collision risk exists to prevent collision with a front vehicle, have become widespread.

Meanwhile, conventional AEB systems fail to sufficiently reflect various road variables, potentially leading to degraded braking performance under specific road conditions, and face difficulties in promptly recognizing risks in rapidly changing traffic situations.

Road gradient, curvature, surface condition, etc., significantly impact safe vehicle driving and act as important variables for the effective operation of AEB systems. For example, steep slopes, sharp curves, slippery roads, or road sections where accidents frequently occur can pose significant risks to driving safety.

Therefore, there is a need for a method and system for controlling a vehicle based on real-time information capable of rapidly recognizing road conditions and change in environment in real-time and reflecting this in the vehicle's AEB system, thereby improving driving safety and braking performance.

### SUMMARY

The present disclosure is to solve the problems of the prior art described above, and an object of the present disclosure is to provide a method and system for controlling a vehicle based on real-time information capable of promptly responding to sudden changes in the road environment through real-time collected road data and cloud-based risk assessment.

Further, an object of the present disclosure is to provide a method and system for controlling a vehicle based on real-time information that enables safe driving by utilizing real-time updated road information via a server, thereby allowing the AEB system to maintain consistent braking performance even under various road conditions.

However, the technical problems to be achieved by the embodiments of the present disclosure are not limited to the technical problems described above, and other technical problems may exist.

As a technical means for achieving the above technical problem, a method for controlling a vehicle based on real-time information according to an embodiment of the present disclosure comprises: recognizing a front vehicle of an ego vehicle; collecting real-time information of a driving road of the ego vehicle from a cloud server; determining a danger level based on the real-time information from the cloud server; controlling an Autonomous Emergency Braking (AEB) function of the ego vehicle based on the danger level; and controlling the ego vehicle according to the controlled AEB function.

Further, the collecting of the real-time information may comprise collecting at least one of road data of the driving road of the ego vehicle, traffic data of the driving road of the ego vehicle, or accident data of the driving road of the ego vehicle.

Further, the road data may comprise data regarding road structure and road condition, and the determining of the danger level may comprise calculating a danger score for determining the danger level according to the road structure and the road condition.

Further, the traffic data may comprise data regarding real-time traffic information and whether the front vehicle performs sudden deceleration, and the determining of the danger level may comprise calculating a danger score for determining the danger level according to the real-time traffic information and whether the front vehicle performs sudden deceleration.

Further, the accident data may comprise data regarding accident tendency and accident type, and the determining of the danger level may comprise calculating a danger score for determining the danger level according to the accident tendency and the accident type.

Further, the determining of the danger level may comprise determining the danger level according to a result value obtained by summing danger scores based on at least one of the road data, the traffic data, or the accident data.

Further, the controlling of the AEB function may comprise controlling at least one of a TTC (Time To Collision) of the AEB function of the ego vehicle, a brake pre-fill, a seatbelt pre-tensioner, or a brake force, according to the determined danger level.

Further, the controlling of the AEB function may comprise adding control types sequentially in an order of the TTC, the brake pre-fill, the seatbelt pre-tensioner, and the brake force as the determined danger level increases.

Further, the cloud server may provide the real-time information of the driving road of the ego vehicle to an HD Map that provides map information to the ego vehicle.

Further, the cloud server may be configured to collect sensor data, vehicle data, and GPS data from the ego vehicle and surrounding vehicles of the ego vehicle.

A system for controlling a vehicle based on real-time information according to embodiments of the present disclosure comprises: a first sensor configured to collect recognition information regarding a front vehicle of an ego vehicle; a second sensor configured to collect real-time information of a driving road of the ego vehicle from a cloud server; and a controller configured to control the ego vehicle based on data collected from the first sensor and the second sensor, the controller comprising: at least one processor configured to determine a danger level based on the real-time information from the cloud server; and an AEB controller configured to control an Autonomous Emergency Braking (AEB) function of the ego vehicle based on the danger level, wherein the controller is configured to control the ego vehicle according to the AEB function controlled by the AEB controller.

Further, the information collected from the cloud server may comprise at least one of road data of the driving road of the ego vehicle, traffic data of the driving road of the ego vehicle, or accident data of the driving road of the ego vehicle.

Further, the road data may comprise data regarding road structure and road condition, and the processor may be configured to calculate a danger score for determining the danger level according to the road structure and the road condition.

Further, the traffic data may comprise data regarding real-time traffic information and whether the front vehicle performs sudden deceleration, and the processor may be configured to calculate a danger score for determining the danger level according to the real-time traffic information and whether the front vehicle performs sudden deceleration.

Further, the accident data may comprise data regarding accident tendency and accident type, and the processor may be configured to calculate a danger score for determining the danger level according to the accident tendency and the accident type.

Further, the processor may be configured to determine the danger level according to a result value obtained by summing danger scores based on at least one of the road data, the traffic data, or the accident data.

Further, the controller may be connected to: a braking apparatus configured to control braking of the ego vehicle; a warning apparatus configured to provide a warning to a driver of the ego vehicle; and a seatbelt adjustment apparatus configured to adjust a seatbelt, and the controller may be configured to control at least one of a TTC, a brake pre-fill, a seatbelt pre-tensioner, or a brake force by controlling at least one of the braking apparatus, the warning apparatus, or the seatbelt adjustment apparatus such that the ego vehicle is controlled according to the AEB function controlled by the AEB controller.

Further, the first sensor may comprise at least one of a front camera, a front radar, or a corner radar, and the second sensor may comprise a GPS sensor and an HD Map.

Further, the system may further comprise a third sensor configured to collect body information of the ego vehicle, wherein the third sensor may comprise at least one of a vehicle speed sensor or a vehicle acceleration sensor.

Meanwhile, in a non-transitory computer-readable recording medium that records a program for executing a method for controlling a vehicle based on real-time information according to an embodiment of the present disclosure, the method comprises: recognizing a front vehicle of an ego vehicle; collecting real-time information of a driving road of the ego vehicle from a cloud server; determining a danger level based on the real-time information from the cloud server; controlling an Autonomous Emergency Braking (AEB) function of the ego vehicle based on the danger level; and controlling the ego vehicle according to the controlled AEB function.

The above-described means for solving the problem is only exemplary and should not be construed as limiting the present disclosure. In addition to the exemplary embodiments described above, additional embodiments may exist in the drawings and the following detailed description.

According to the problem-solving means of the present disclosure described above, by integrating real-time collected traffic data, road conditions, weather conditions, accident-prone section information, etc., the driving risk can be predicted more accurately, thereby providing a vehicle control method and system capable of enabling the AEB system to exhibit optimal braking performance even in emergency situations immediately preceding an accident.

Further, according to the problem-solving means of the present disclosure, by utilizing cloud-based data integration and predictive analysis, it is possible to provide a method and system for controlling a vehicle that can recognize road danger factors and respond to those in advance, and that can reduce post-accident recovery costs and increase the efficiency of vehicle maintenance.

However, the effects obtainable from the present disclosure are not limited to the effects described above, and other effects may exist.

### BRIEF DESCRIPTION OF THE DRAWINGS

FIG. 1 is a control flowchart showing a method for controlling a vehicle based on real-time information according to an embodiment of the present disclosure.

FIG. 2 is a control flowchart showing in more detail the danger level determination step in the method for controlling the vehicle based on real-time information according to the embodiment of the present disclosure.

FIG. 3 is a conceptual diagram showing a method of providing data from an ego vehicle and other vehicles to a cloud server and performing danger analysis at the cloud server, in the method for controlling the vehicle based on real-time information according to the embodiment of the present disclosure.

FIG. 4 is a diagram illustratively showing a method for calculating a danger score based on road data in the method for controlling the vehicle based on real-time information according to the embodiment of the present disclosure.

FIG. 5A is a diagram illustratively showing a method for calculating a danger score based on traffic data, and FIG. 5B is a diagram illustratively showing a method for calculating a danger score based on accident data, in the method for controlling the vehicle based on real-time information according to the embodiment of the present disclosure.

FIG. 6 is a diagram showing a danger level determination based on danger score calculation and a control method of the AEB function according to the danger level, in the method for controlling the vehicle based on real-time information according to the embodiment of the present disclosure.

FIG. 7 is a control configuration diagram schematically showing configuration of a system for controlling a vehicle based on real-time information according to embodiments of the present disclosure.

### DETAILED DESCRIPTION

Hereinafter, with reference to the accompanying drawings, embodiments of the present disclosure will be described in detail so that those skilled in the art can easily practice the embodiments. However, the present disclosure may be implemented in many different forms and is not limited to the embodiments described herein. In addition, in order to clearly describe the present disclosure in the drawings, parts irrelevant to the description are omitted, and similar reference numerals are attached to similar parts throughout the present disclosure.

Throughout the present disclosure, if a part is said to be “connected” to another part, it is not only “directly connected”, but also “electrically connected” with another element in between, including cases where

### They Are “indirectly Connected”.

Throughout the present disclosure, if one member is said to be located “on”, “above”, “under”, or “below” the other member, this includes not only the case of being in contact with the other member, but also the case that another member is positioned between the two members.

Throughout the present disclosure, if a part “includes” a certain component, it does not mean excluding other components, and it does mean that it may further include other components, unless otherwise stated.

Various embodiments of the present disclosure generally relate to a method and system for controlling a vehicle based on real-time information, which controls the Autonomous Emergency Braking function of the vehicle according to a danger level determined based on real-time information provided from a cloud server.

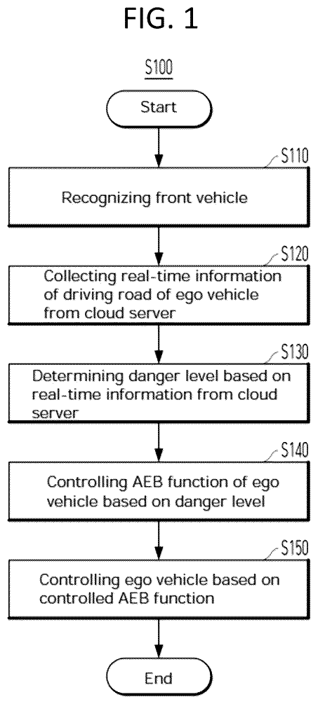

FIG. 1 is a control flowchart showing a method for controlling a vehicle based on real-time information according to an embodiment of the present disclosure.

Referring to FIG. 1, the method for controlling a vehicle based on real-time information S100 according to an embodiment of the present disclosure may comprise recognizing a front vehicle of an ego vehicle S110.

Meanwhile, the front vehicle of the ego vehicle may be recognized through at least one sensor installed in the ego vehicle. For example, the front vehicle may be recognized by a front camera or a front radar installed in the ego vehicle, but is not limited thereto, and the front vehicle may also be recognized by sensors capable of recognizing the surroundings of the ego vehicle, such as ultrasonic sensors, lidar, etc.

Subsequently, collecting real-time information of the driving road of the ego vehicle from a cloud server S120 may be performed.

The cloud server here may provide real-time information of the driving road to the ego vehicle on an HD Map (High-Definition Map) that provides map information to the ego vehicle. For example, the real-time information according to the embodiment may be information provided from a cloud server in a Road Experience Management (REM) system including an HD Map and a cloud server.

Further, the real-time information of the driving road of the ego vehicle according to the embodiment may be at least one of road data, traffic data, or accident data of the driving road of the ego vehicle.

The road data of the driving road may include data regarding road structure and road condition. The traffic data of the driving road may include data regarding real-time traffic information and whether a front vehicle performs sudden deceleration. Further, the accident data of the driving road may include data regarding accident tendency and accident type.

Next, determining a danger level based on the real-time information from the cloud server S130 may be performed.

Specifically, if the real-time information from the cloud server is road data of the driving road, the danger level determination step (S130) may include calculating a danger score for determining the danger level according to the road structure and road condition.

Further, if the real-time information from the cloud server is traffic data of the driving road, the danger level determination step S130 may include calculating a danger score for determining the danger level according to the real-time traffic information and whether the front vehicle performs sudden deceleration.

Further, if the real-time information from the cloud server is accident data of the driving road, the danger level determination step S130 may include calculating a danger score for determining the danger level according to the accident tendency and accident type.

The danger level determination step S130 may determine the danger level according to a result value obtained by summing all danger scores based on at least one of the road data, traffic data, or accident data.

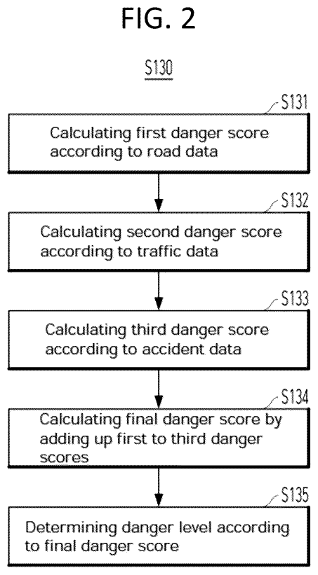

The method of determining the danger level by summing danger scores will be described in more detail with reference to FIG. 2. FIG. 2 is a control flowchart showing in more detail the danger level determination step in the method for controlling the vehicle based on real-time information according to the embodiment of the present disclosure.

Referring to FIG. 2, first, a first danger score may be calculated based on road data including data regarding road structure and road condition (S131). Further, a second danger score may be calculated based on traffic data including data regarding real-time traffic information and whether a front vehicle performs sudden deceleration (S132). Further, a third danger score may be calculated based on accident data including data regarding accident tendency and accident type (S133).

Next, a final danger score may be calculated by summing the calculated first danger score, second danger score, and third danger score (S134), and a danger level may be determined according to the final danger score (S135).

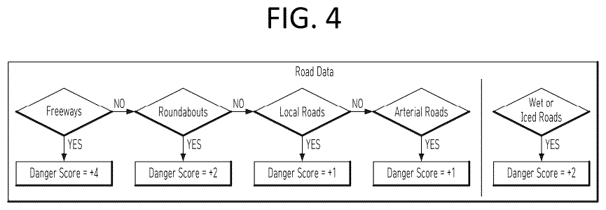

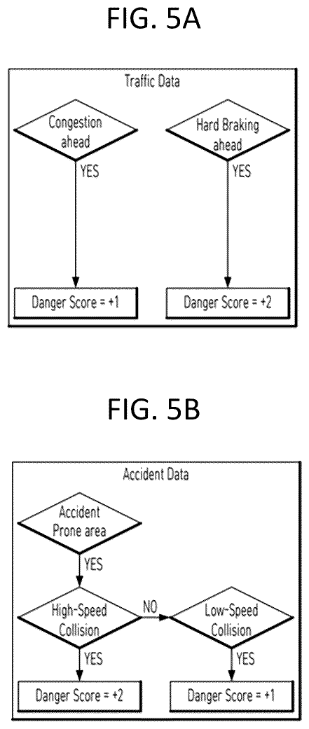

Meanwhile, the first to third danger scores based on real-time data may be pre-set values. Regarding the specific danger score values based on real-time data, a detailed description will be provided with reference to the examples in FIG. 4 and FIGS. 5A to 5B.

Referring again to FIG. 1, once the danger level is determined in the danger level determination step S130, controlling the AEB function of the ego vehicle based on the danger level S140 may be performed. Subsequently, controlling the ego vehicle according to the controlled AEB function S150 may be performed.

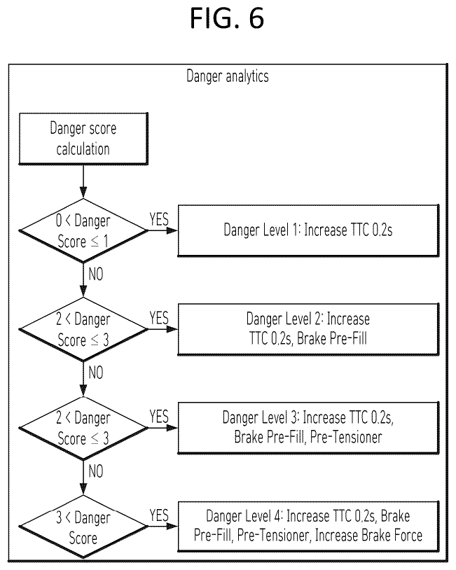

Regarding the determination of the danger level based on the calculated danger score, and the control of the AEB function of the ego vehicle according to the danger level, a more detailed description will be provided with reference to FIG. 6.

According to the method for controlling a vehicle based on real-time information according to the embodiment described above, by utilizing real-time data regarding the driving road of the ego vehicle from the cloud server, the danger situation can be recognized in real-time. Also, it is possible to classify the danger level specifically and respond accordingly by analyzing the danger situation, thereby significantly improving the performance of the AEB system.

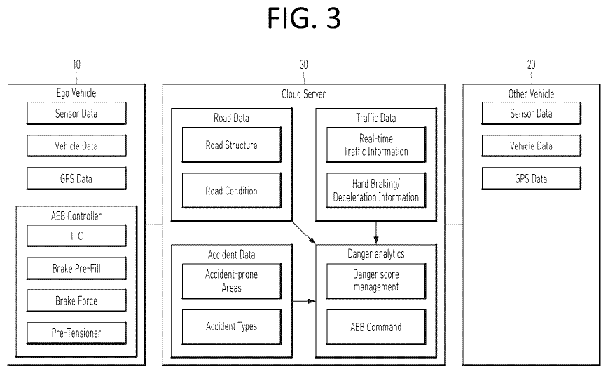

FIG. 3 is a conceptual diagram showing a method of providing data from an ego vehicle and other vehicles to a cloud server and performing danger analysis at the cloud server, in the method for controlling the vehicle based on real-time information according to the embodiment of the present disclosure.

Referring to FIG. 3, a cloud server 30 according to the embodiment may receive vehicle data from the driving ego vehicle 10 and surrounding other vehicles 20.

Specifically, the cloud server 30 may be configured to collect sensor data, vehicle data, and GPS data from the ego vehicle 10 and other vehicles 20.

Including the real-time data collected from the vehicles, the cloud server may collect road data, traffic data, and accident data of the driving road where the ego vehicle is driving, and perform danger analytics using collected data.

Based on the danger level determined through the danger analysis, the ego vehicle 10 may control at least one of a TTC (Time To Collision), a brake pre-fill, a seatbelt pre-tensioner, or a brake force of the AEB function by a AEB controller. The specific method for controlling the AEB function will be described in more detail with reference to FIG. 6.

FIG. 4 is a diagram illustratively showing a method for calculating a danger score based on road data in the method for controlling the vehicle based on real-time information according to the embodiment of the present disclosure.

Referring to FIG. 4, for example, if the road structure in the road data provided by the cloud server is a freeway, the danger score may be determined as +4. Further, if the road structure is a roundabout, the danger score may be determined as +2. Further, if the road structure is a local road or an arterial road, the danger score may be determined as +1.

Meanwhile, based on the road condition data in the road data provided by the cloud server, for example, if the road condition is wet road or iced road, the danger score may be determined as +2. Meanwhile, since the road structure and road condition may be determined independently, for example, if a freeway is wet, the danger score may be +6 (4+2).

Here, each danger score may be a pre-set value. For example, the danger score according to the road structure may be set considering the driving speed and curvature of the road. For example, in the case of a freeway, although the curvature is relatively low, the driving speed is fast, so the danger score may be high. In the case of a roundabout, although the driving speed is slow, the curvature is large, so the danger score may be set higher than that of a local road or an arterial road.

FIG. 5A is a diagram illustratively showing a method for calculating a danger score based on traffic data, and FIG. 5B is a diagram illustratively showing a method for calculating a danger score based on accident data, in the method for controlling the vehicle based on real-time information according to the embodiment of the present disclosure.

Referring to FIG. 5A, for example, if the real-time traffic information in the traffic data provided by the cloud server indicates a congested situation ahead of the ego vehicle (Congestion ahead), the danger score may be determined as +1. Further, in the data regarding sudden deceleration in the traffic data provided by the cloud server, if the front vehicle performs hard braking (Hard Braking ahead), the danger score may be determined as +2.

Further, referring to FIG. 5B, based on the accident data provided by the cloud server, if the driving area of the ego vehicle is an accident-prone area according to accident tendency data, the accident type may be distinguished. If the accident type is a high-speed collision, the danger score may be determined as +2, and if the accident type is a low-speed collision, the danger score may be determined as +1.

Referring to the danger scores shown in FIG. 4 and FIGS. 5A to 5B, an example of summing the danger scores may be illustrated. For example, if the ego vehicle is driving on a local road (+1) which is wet (+2), in a congested section (+1), where low-speed accidents frequently occur (+1), the summed final danger score may be +5 (1+2+1+1).

Meanwhile, the danger scores set in FIG. 4 and FIGS. 5A to 5B are shown expressed in units of +1, but depending on the specific road situation, the danger score may be set as +0.5, +1.5, etc. Further, there may also be cases where the danger score is 0.

Further, although not illustrated in FIG. 4 and FIGS. 5A to 5B, danger scores for various road situations may be set. For example, danger scores may be set for weather conditions of the road or occurrences of natural disasters.

FIG. 6 is a diagram showing a danger level determination based on danger score calculation and a control method of the AEB function according to the danger level, in the method for controlling the vehicle based on real-time information according to the embodiment of the present disclosure.

The road data and respective danger scores may be calculated by the method illustrated above, and the final danger score may be calculated by summing the danger scores. Further, based on the calculated final danger score, the danger level may be determined.

Referring to FIG. 6, for example, if the final danger score is greater than 0 and less than or equal to 1, the danger level may be determined as Level 1. The AEB control for Danger level 1 may involve increasing the TTC (Time To Collision) related to AEB operation by 0.2 seconds(s).

That is, in Level 1, the AEB system operation timing for the front vehicle may be advanced by 0.2 seconds compared to the normal case by increasing the TTC for AEB operation by 0.2 seconds.

Further, referring to FIG. 6, for example, if the final danger score is greater than 1 and less than or equal to 2, the danger level may be determined as Level 2. The AEB control for Level 2 may involve, in addition to increasing the TTC related to AEB operation by 0.2 seconds(s), additionally performing a brake pre-fill control.

The brake pre-fill may refer to a brake control that enhances braking responsiveness and achieves an immediate brake feeling by pre-filling the brake hydraulic pressure in sudden braking situations.

Further, referring to FIG. 6, for example, if the final danger score is greater than 2 and less than or equal to 3, the danger level may be determined as Level 3. The AEB control for Level 3 may involve, in addition to the TTC control and the brake pre-fill control related to AEB operation, additionally performing a seatbelt pre-tensioner control.

The seatbelt pre-tensioner control may refer to a seatbelt control that prevents occupant injury by retracting the seatbelt from the exit side during a vehicle collision while simultaneously reducing pressure applied to the occupant's upper body by feeding the seatbelt back out.

Further, referring to FIG. 6, for example, if the final danger score exceeds 3, the danger level may be determined as Level 4. The AEB control for Level 4 may involve, in addition to the TTC control, the brake pre-fill control, and the seatbelt pre-tensioner control related to AEB operation, additionally performing control to increase a brake force. The brake force increase control allows for more rapid emergency braking of the vehicle upon brake pedal operation.

As shown in FIG. 6, according to the embodiment, as the determined danger level increases, control types such as the TTC, the brake pre-fill, the seatbelt pre-tensioner, and the brake force control may be added sequentially in the step of controlling the AEB function. However, the present disclosure is not limited thereto, and for example, the amount of TTC increase or brake force increase may be adjusted, or the operation timing of the brake pre-fill or the seatbelt pre-tensioner may be advanced, etc., allowing the degree or timing of control to be changed according to the danger level.

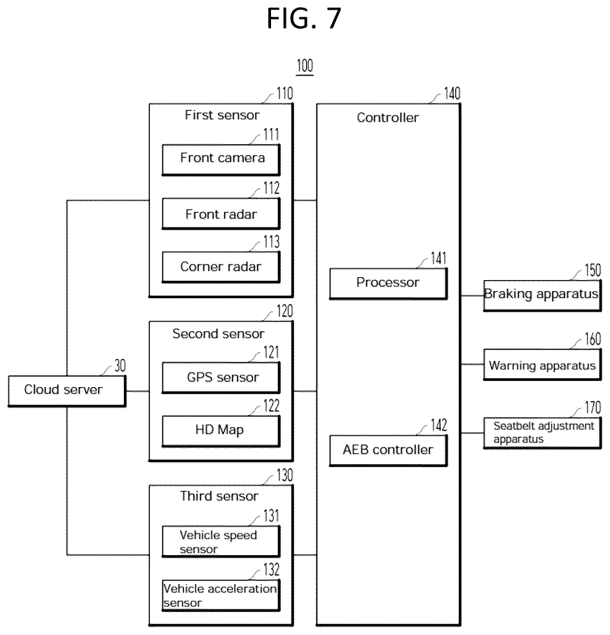

FIG. 7 is a control configuration diagram schematically showing configuration of a system for controlling a vehicle based on real-time information according to embodiments of the present disclosure.

Referring to FIG. 7, the system for controlling a vehicle based on real-time information 100 according to embodiments of the present disclosure may comprise: a first sensor 110 configured to collect recognition information of a front vehicle of an ego vehicle; a second sensor 120 configured to collect real-time information of a driving road of the ego vehicle from a cloud server 30; and a controller 140 configured to control the ego vehicle based on the data collected from the first sensor 110 and the second sensor 120.

The controller 140 may comprise: at least one processor 141 for determining a danger level based on the real-time information from the cloud server 30; and an AEB controller 142 for controlling the AEB function of the ego vehicle based on the danger level.

Further, the controller 140 may control the ego vehicle according to the AEB function controlled by the AEB controller 142.

Further, the system for controlling a vehicle based on real-time information 100 according to the embodiments may comprise a third sensor 130 configured to detect body information of the ego vehicle.

The first sensor 110 may include at least one of a front camera 111, a front radar 112, or a corner radar 113 installed at the ego vehicle, and the front vehicle (AEB control target) located ahead of the ego vehicle may be detected through the sensor(s). However, the types of sensors included in the first sensor 110 are not limited thereto, and may include other types of sensors such as ultrasonic sensors, lidar sensors, etc., for detecting the surroundings of the vehicle and the front vehicle.

Meanwhile, the sensor data detected by the first sensor 110 may be provided to the cloud server and used for collecting data (real-time information) of the driving road of the ego vehicle.

The second sensor 120 may comprise a GPS sensor 121 and an HD Map (High-Definition Map) 122. The HD Map 122 may download map information including real-time information of the driving road of the ego vehicle through the cloud server 30 and provide it to the driver of the ego vehicle.

The third sensor 130 may comprise at least one of a vehicle speed sensor 131 for detecting the speed of the ego vehicle or a vehicle acceleration sensor 132 for detecting the acceleration of the ego vehicle. However, the configuration of the sensors included in the third sensor 130 is not limited thereto, and may include other types of sensors for detecting the body information of the ego vehicle, such as a steering angle sensor, a steering torque sensor, etc.

Meanwhile, the body information data detected by the third sensor 130 may be provided to the cloud server and used for collecting data (real-time information) of the driving road of the ego vehicle.

The information collected from the cloud server 30 may include at least one of road data, traffic data, or accident data of the driving road of the ego vehicle.

The processor 141 of the controller 140 may calculate a danger score for determining the danger level according to the road structure and road condition included in the road data; calculate a danger score for determining the danger level according to the real-time traffic information and whether the front vehicle performs sudden deceleration included in the traffic data; and calculate a danger score for determining the danger level according to the accident tendency and accident type included in the accident data.

Further, the processor 141 may determine the danger level according to the result value obtained by summing all danger scores based on at least one of the road data, traffic data, or accident data.

Meanwhile, the AEB controller 142 of the controller 140 may send a control command to control at least one of the TTC, the brake pre-fill, the seatbelt pre-tensioner, or the brake force of the AEB function according to the determined danger level.

The controller 140 may be connected to a braking apparatus 150 configured to control the braking of the ego vehicle, a warning apparatus 160 configured to provide a warning to the driver of the ego vehicle, and a seatbelt adjustment apparatus 170 configured to adjust the seatbelt. Accordingly, the controller 140 may control at least one of the braking apparatus 150, the warning apparatus 160, or the seatbelt adjustment apparatus 170 such that the ego vehicle is controlled according to the AEB function controlled by the AEB controller 142, thereby controlling at least one of the TTC, the brake pre-fill, the seatbelt pre-tensioner, or the brake force of the AEB function.

Regarding the method for controlling a vehicle based on real-time information according to the embodiment of the present disclosure performed by the controller 140, since it has been described in detail previously, a detailed description thereof will be omitted here.

The disclosed embodiments may also be implemented as a computer-readable program on a computer-readable recording medium in order to be executed by a computer. A computer-readable recording medium may be a non-transitory computer-readable recording medium, such as a data storage device capable of storing data that may be read by a processor/microprocessor.

Examples of computer-readable recording media may include hard disk drives (HDD), solid-state drives (SSD), silicon disk drives (SDD), read-only memory (ROM), CD-ROM, magnetic tape, floppy disks, optical data storage devices, etc.

According to the embodiments of the present disclosure as described above, it is possible to provide a method and system for controlling a vehicle based on real-time information that can dynamically adjust the AEB warning and braking timing according to the road situation, through real-time collected driving road data and cloud-based danger assessment.

Further, according to the method and system for controlling a vehicle based on real-time information according to the embodiments, by utilizing cloud-based data integration and predictive analysis, road danger factors can be recognized and responded to in advance, and also, by utilizing real-time updated road structure and condition information, consistent braking performance of the AEB system can be maintained even under various road conditions.

The above description of the present disclosure is for illustrative purposes, and those skilled in the art may understand that it can be easily modified into other specific forms without changing the technical spirit or essential features of the present disclosure. Therefore, the embodiments described above should be understood as illustrative in all respects and not limiting. For example, each component described as a single type may be implemented in a distributed manner, and similarly, components described as distributed may be implemented in a combined form.

The scope of the present disclosure is indicated by the following claims rather than the above detailed description, and all changes or modifications derived from the meaning and scope of the claims and equivalent concepts should be interpreted to be included in the scope of the present disclosure.

### EXPLANATION OF REFERENCE

10: Ego vehicle
20: Other vehicle
30: Cloud server
100: System for controlling vehicle based on real-time information
110: First sensor
111: Front camera
112: Front radar
113: Corner radar
120: Second sensor
121: GPS sensor
122: HD Map
130: Third sensor
131: Vehicle speed sensor
132: Vehicle acceleration sensor
140: Controller
141: Processor
142: AEB controller
150: Braking apparatus
160: Warning apparatus
170: Seatbelt adjustment apparatus

1. A method for controlling a vehicle based on real-time information, comprising:
recognizing a front vehicle of an ego vehicle;
collecting real-time information of a driving road of the ego vehicle from a cloud server;
determining a danger level based on the real-time information from the cloud server;
controlling an Autonomous Emergency Braking (AEB) function of the ego vehicle based on the danger level; and
controlling the ego vehicle according to the controlled AEB function.

2. The method of claim 1, wherein the collecting of the real-time information comprises collecting at least one of road data of the driving road of the ego vehicle, traffic data of the driving road of the ego vehicle, or accident data of the driving road of the ego vehicle.

3. The method of claim 2, wherein the road data comprises data regarding road structure and road condition, and
wherein the determining of the danger level comprises calculating a danger score for determining the danger level according to the road structure and the road condition.

4. The method of claim 3, wherein the traffic data comprises data regarding real-time traffic information and whether the front vehicle performs sudden deceleration, and
wherein the determining of the danger level comprises calculating a danger score for determining the danger level according to the real-time traffic information and whether the front vehicle performs sudden deceleration.

5. The method of claim 4, wherein the accident data comprises data regarding accident tendency and accident type, and
wherein the determining of the danger level comprises calculating a danger score for determining the danger level according to the accident tendency and the accident type.

6. The method of claim 5, wherein the determining of the danger level comprises determining the danger level according to a result value obtained by summing danger scores based on at least one of the road data, the traffic data, or the accident data.

7. The method of claim 6, wherein the controlling of the AEB function comprises controlling at least one of a TTC (Time To Collision) of the AEB function of the ego vehicle, a brake pre-fill, a seatbelt pre-tensioner, or a brake force, according to the determined danger level.

8. The method of claim 7, wherein the controlling of the AEB function comprises adding control types sequentially in an order of the TTC, the brake pre-fill, the seatbelt pre-tensioner, and the brake force as the determined danger level increases.

9. The method of claim 1, wherein the cloud server provides the real-time information of the driving road of the ego vehicle to an HD Map that provides map information to the ego vehicle.

10. The method of claim 9, wherein the cloud server is configured to collect sensor data, vehicle data, and GPS data from the ego vehicle and surrounding vehicles of the ego vehicle.

11. A system for controlling a vehicle based on real-time information, comprising:
a first sensor configured to collect recognition information regarding a front vehicle of an ego vehicle;
a second sensor configured to collect real-time information of a driving road of the ego vehicle from a cloud server; and
a controller configured to control the ego vehicle based on data collected from the first sensor and the second sensor, the controller comprising: at least one processor configured to determine a danger level based on the real-time information from the cloud server; and an AEB controller configured to control an Autonomous Emergency Braking (AEB) function of the ego vehicle based on the danger level,
wherein the controller is configured to control the ego vehicle according to the AEB function controlled by the AEB controller.

12. The system of claim 11, wherein the information collected from the cloud server comprises at least one of road data of the driving road of the ego vehicle, traffic data of the driving road of the ego vehicle, or accident data of the driving road of the ego vehicle.

13. The system of claim 12, wherein the road data comprises data regarding road structure and road condition, and
wherein the processor is configured to calculate a danger score for determining the danger level according to the road structure and the road condition.

14. The system of claim 13, wherein the traffic data comprises data regarding real-time traffic information and whether the front vehicle performs sudden deceleration, and
wherein the processor is configured to calculate a danger score for determining the danger level according to the real-time traffic information and whether the front vehicle performs sudden deceleration.

15. The system of claim 14, wherein the accident data comprises data regarding accident tendency and accident type, and
wherein the processor is configured to calculate a danger score for determining the danger level according to the accident tendency and the accident type.

16. The system of claim 15, wherein the processor is configured to determine the danger level according to a result value obtained by summing danger scores based on at least one of the road data, the traffic data, or the accident data.

17. The system of claim 11, wherein the controller is connected to: a braking apparatus configured to control braking of the ego vehicle; a warning apparatus configured to provide a warning to a driver of the ego vehicle; and a seatbelt adjustment apparatus configured to adjust a seatbelt, and
wherein the controller is configured to control at least one of a TTC, a brake pre-fill, a seatbelt pre-tensioner, or a brake force by controlling at least one of the braking apparatus, the warning apparatus, or the seatbelt adjustment apparatus such that the ego vehicle is controlled according to the AEB function controlled by the AEB controller.

18. The system of claim 11, wherein the first sensor comprises at least one of a front camera, a front radar, or a corner radar, and the second sensor comprises a GPS sensor and an HD Map.

19. The system of claim 11, further comprising a third sensor configured to collect body information of the ego vehicle, wherein the third sensor comprises at least one of a vehicle speed sensor or a vehicle acceleration sensor.

20. A non-transitory computer-readable recording medium that records a program for executing a method for controlling a vehicle based on real-time information on a computer, the method comprising:
recognizing a front vehicle of an ego vehicle;
collecting real-time information of a driving road of the ego vehicle from a cloud server;
determining a danger level based on the real-time information from the cloud server;
controlling an Autonomous Emergency Braking (AEB) function of the ego vehicle based on the danger level; and
controlling the ego vehicle according to the controlled AEB function.
